(19) United States
(12) Patent Application Publication
(10) Pub. No.: US 2005/0108203 A1
(43) Pub. Date: May 19, 2005

(54) Sample-directed searching in a peer-to-peer system

(76) Inventors: Chunqiang Tang, Rochester, NY (US); Zhichen Xu, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/705,932

(22) Filed: Nov. 13, 2003

(51) Int. Cl. G06F 17/30

(52) U.S. Cl. 707/3

(57) ABSTRACT

A peer-to-peer system includes a destination node operable to receive a query. The destination node receives samples from a first set of nodes proximally located to the destination node in an overlay network for the peer-to-peer system. The samples are associated with information stored at the proximally located nodes. The destination node is operable to identify, based on the samples received from the first set of nodes, a first node of the first set of nodes likely storing information associated with objects stored in the peer-to-peer system that are relevant to the query.

### FIELD OF THE INVENTION

This invention relates generally to network systems. More particularly, the invention relates to searching in a peer-to-peer network.

### BACKGROUND

Peer-to-peer (P2P) systems are gaining popularity due to their scalability, fault-tolerance, and self-organizing nature. P2P systems are widely known for their file sharing capabilities. Well-known file sharing applications, such as KAZAA, MORPHEUS, GNUTELLA, NAPSTER, etc., utilize P2P systems for large-scale data storage. In addition to file sharing, progress is being made for utilizing P2P systems to implement DNS, media streaming, and web caching.

Recently, distributed hash table (DHT) overlay networks have been used for data placement and retrieval in P2P systems. The overlay networks are logical representations of the underlying physical P2P system, which provide, among other types of functionality, data placement, information retrieval, routing, etc. Some examples of DHT overlay networks include content-addressable-network (CAN), PASTRY, and CHORD.

Data is represented in an overlay network as a (key, value) pair, such as (K1,V1). K1 is deterministically mapped to a point P in the overlay network using a hash function, e.g., P=h(K1). The key-value pair (K1, V1) is then stored at the point P in the overlay network, i.e., at the node owning the zone where point P lies. The same hash function is used to retrieve data. The hash function is used to calculate the point P from K1. Then, the data is retrieved from the point P. This is further illustrated with respect to the 2-dimensional CAN overlay network 700 shown in FIG. 7.

A CAN overlay network logically represents the underlying physical network using a d-dimensional Cartesian coordinate space on a d-torus. FIG. 7 illustrates a 2-dimensional [0,1]×[0,1] Cartesian coordinate space used by the overlay network 700. The Cartesian space is partitioned into CAN zones 710-714 owned by nodes A-E, respectively. The nodes A-E each maintain a coordinate routing table that holds the IP address and virtual coordinate zone of each of its immediate neighbors. Two nodes are neighbors (i.e., neighbor nodes) if their zones overlap along d−1 dimensions and abut along one dimension. For example, nodes B and D are neighbor nodes, but nodes B and C are not neighbor nodes because their zones 711 and 714 do not abut along one dimension. Each node in the overlay network 700 owns a zone. The coordinates for the zones 710-714 are shown.

Routing in the overlay network 700 is performed by routing to a destination node through neighbor nodes. Assume the node B is retrieving data from a point P in the zone 714 owned by the node C. Because the point P is not in the zone 711 or any of the neighbor zones of the node B, the request for data is routed through the neighbor zone 713 owned by the node D to the node C, which owns the zone 714 where point P lies, for retrieving the data. The node C may be described as a 2-hop neighbor node to the node B, and the node D is a neighbor node to the node B because the zones 711 and 713 overlap along one dimension. Thus, a CAN message includes destination coordinates, such as the coordinates for the point P, determined using the hash function. Using the sources node's neighbor coordinate set, the source node routes the request by simple greedy forwarding to the neighbor node with coordinates closest to the destination node coordinates, such as shown in the path B-D-C.

One important aspect of P2P systems, including P2P systems represented using a DHT overlay network, is searching. Searching allows users to retrieve desired information from the typically enormous storage space of a P2P system. Current P2P searching systems are typically not scalable or unable to provide deterministic performance guarantees. More specifically, current P2P searching systems are substantially based on centralized indexing, query flooding, index flooding, or heuristics.

Centralized indexing P2P searching systems, such as NAPSTER, suffer from a single point of failure and performance bottleneck at the index server. Thus, if the index server fails or is overwhelmed with search requests, searching may be unavailable or unacceptably slow. Flooding-based techniques, such as GNUTELLA, send a query or index to every node in the P2P system, and thus, consume large amounts of network bandwidth and CPU cycles. Heuristics-based techniques try to improve performance by directing searches to only a fraction of the nodes in the P2P system but the accuracy of the search results tends to be much less than the other search techniques.

### SUMMARY OF THE EMBODIMENTS

According to an embodiment, a method for executing a search in a peer-to-peer system includes receiving a query at a destination node and receiving samples from a first set of nodes proximally located to the destination node in an overlay network for the peer-to-peer system. The samples are associated with information stored at the proximally located nodes. The method further includes identifying, based on the samples received from the first set of nodes, a first node of the first set of nodes likely storing information associated with objects stored in the peer-to-peer system that are relevant to the query. According to another embodiment, a computer readable medium on which is embedded a program is provided. The program performs the above-described method.

According to yet another embodiment, an apparatus for executing a search in a peer-to-peer system includes means for receiving a query at a destination node and means for receiving samples from a first set of nodes proximally located to the destination node in an overlay network for the peer-to-peer system. The samples are associated with information stored at the proximally located nodes. The apparatus also includes means for identifying, based on the samples received from the first set of nodes, a first node of the first set of nodes likely storing information associated with objects stored in the peer-to-peer system that are relevant to the query.

According to yet another embodiment, a peer-to-peer system includes a plurality of nodes in the system operating as a search engine operable to execute a query received by the search engine. An overlay network is implemented by the plurality of nodes. A plurality of indices is stored at the plurality of nodes, and each index includes at least one semantic vector for an object. A first node in the search engine is operable to receive samples from nodes proximally located to the first node in the overlay network. The first node utilizes the samples to identify an index of one of the other nodes to search in response to receiving the query.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates an overlay network, according to an embodiment;

FIG. 2 illustrates a P2P system, according to an embodiment;

FIG. 3 illustrates a software architecture of a peer search node, according to an embodiment;

FIG. 4 illustrates a method for executing a query, according to an embodiment;

FIG. 5 illustrates a method for generating samples, according to an embodiment;

FIG. 6 illustrates a computer system that may be used as a peer search node, according to an embodiment; and

FIG. 7 illustrates a prior art DHT overlay network.

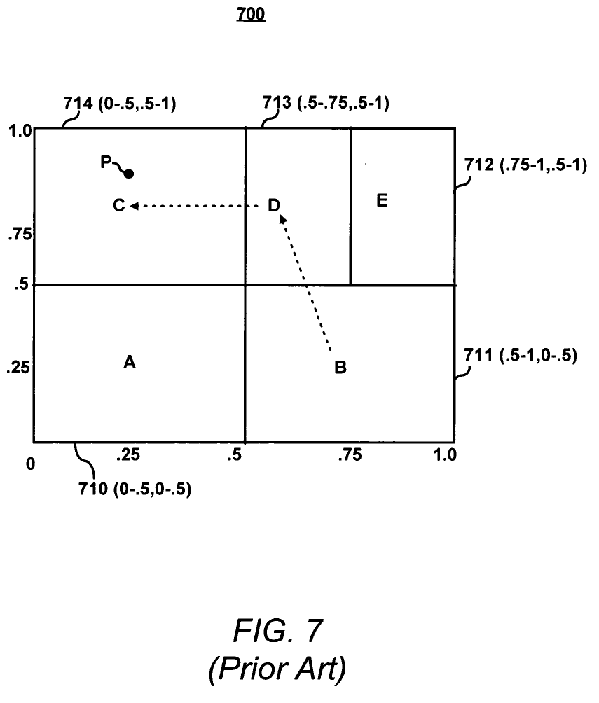

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that variations are possible without departing from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Conventional P2P systems randomly distribute documents in the P2P system. Thus, in order to avoid missing a large number of documents relevant to a search, a P2P searching system has to search a large number of nodes in a conventional P2P system. According to an embodiment, a semantic overlay network is generated for a P2P system. The semantic overlay network is a network where contents are organized around their semantics such that the distance (e.g., routing hops) between two objects (or key-value pairs representing the objects) stored in the P2P system is proportional to their similarity in semantics. Hence, similar documents are stored in close proximity. Thus, a smaller number of nodes in close proximity may be searched without sacrificing the accuracy of the search results.

Semantics are the attributes of an object stored in the P2P system. An object may include any type of data (e.g., text documents, web pages, music, video, software code, etc.). A semantic of a document, for example, may include the frequency of key words used in the document. By way of example, documents are used herein to describe the embodiments. However, the embodiments are generally applicable to any type of object stored in the P2P system. Also, semantic vectors may be used to store semantics of an object in the P2P system. Semantic vectors are described in further detail below.

According to an embodiment, a P2P searching network is provided for searching for desired information stored in a P2P system. In particular, a subset of the peers (or nodes) in the P2P system implement a peer search network. The peer search network may be logically represented as the semantic, overlay network. The overlay network may include a d-torus logical space, where d is the number of dimensions in the logical space. The overlay network may include any type of DHT overlay network, such as CAN, CHORD, PASTRY, etc. In one embodiment, an expressway routing CAN overlay network (eCAN) may be used. An eCAN overlay network is further described in U.S. patent application Ser. No. 10/231,184, entitled, “Expressway Routing Among Peers”, filed on Aug. 29, 2002 and hereby incorporated by reference in its entirety. The eCAN overlay network 100 augments the principles of a CAN overlay network. The eCAN overlay network augments CAN's routing capacity with routing tables of larger span to improve routing performance. In one embodiment using eCAN or CAN, the logical space is divided into fundamental (or basic) zones where each node of the subset of peers is an owner. Additional zones are formed over the fundamental zones.

In the peer search network, objects (e.g., text documents, web pages, video, music, data, etc.) may be represented by a key-value pair including a semantic vector (i.e., the key) and an address (i.e., the value). The address may include the object itself or an address for the object, such as a universal resource locator (URL), a network address, etc.

A semantic vector is a semantic information space representation of an object stored in the P2P system. The semantic vector may be determined by applying a latent-semantic indexing (LSI) algorithm or any IR algorithms that can derive a vector representation of objects. Many of the embodiments described herein reference vector representations of documents stored in the peer-to-peer network. However, semantic vectors may be generated for other types of data objects (e.g., music, video, web pages, etc.). For example, a semantic vector for a music file may include information regarding tempo.

LSI uses statistically derived conceptual indices instead of individual terms for retrieval. LSI may use known singular value decomposition (SVD) algorithms to transform a high-dimensional term vector (i.e., a vector having a large number of terms which may be generated using known vector space modeling algorithms) into a lower-dimensional semantic vector by projecting the high-dimension vector into a semantic subspace. For example, a document or information regarding the document is to be stored in the P2P system. A semantic vector is generated for the document. Each element of the semantic vector corresponds to the importance of an abstract concept in the document or query instead of a term in the document. Also, SVD sorts elements in semantic vectors by decreasing importance. Thus, for an SVD-generated semantic vector vi=v0, v1, v2, v3, the lower elements (e.g., v0 and v1) represent concepts that are more likely to identify relevant documents or other information in response to a query. The lower elements, for example, have higher hit rates.

The following describes generation of a semantic vector. Let d denote the number of documents in a corpus, and t denote the number of terms in a vocabulary. Vector space modeling algorithms may be used to represent this corpus as a t×d matrix, A, whose entry, aij, indicates the importance of term, i, in the document j. Suppose the rank of A is r. SVD decomposes A into the product of three matrices, A=UΣV^{T}, where Σ=diag(δ1;:::; δr) is an r×r diagonal matrix, U=(u1;:::; ur) is a t×r matrix, and V=(v1;:::; vr) is a d×r matrix. δi are A's singular values, δ1≧δ2≧:::≧δr.

In one embodiment, LSI approximates the matrix A of rank r with a matrix Al of lower rank l by omitting all but the largest singular values. Let Σz=diag(δ1;:::; δz), U1=(u1;:::; uz), and V1=(v1;:::; vz). Thus the matrix Az is calculated using the following equation: Az=UzΣzVz^{T}.

Among all matrices of rank z, Az approximates A with the smallest error. The rows of VzΣz are the semantic vectors for documents in the corpus. Given Uz, Vz, and Σz, the semantic vectors of queries, terms, or documents originally not in A can be generated by folding them into the semantic subspace of a lower rank. By choosing an appropriate z for Az, the important structure of the corpus is retained while noise is minimized. In addition, LSI can bring together documents that are semantically related even if they do not share terms. For instance, a query or search using “car” may return relevant documents that actually use “automobile” in the text.

The semantic vector also indicates a location in the peer search network. As described above, objects in the peer search network may be represented by a key-value pair comprising a semantic vector and an address. The semantic vector is hashed to identify a point (or node) in the overlay network for storing the key-value pair. The key-value pair is then routed to a node owner of a zone where the semantic vector falls in the peer search network. That is the key-value pair is routed to the node owner of the zone where the identified point falls in the overlay network. Indices including key-value pairs are stored at a node and possibly neighbor nodes. These indices may be searched in response to a query.

By using a semantic vector to derive a location in the peer search network for storing a key-value pair, key-value pairs having similar information are stored in close proximity (e.g., within a limited number of routing hops). Therefore, instead of flooding a query to an entire P2P system, a limited number of nodes in close proximity in the peer search network may be searched to determine the results of a query.

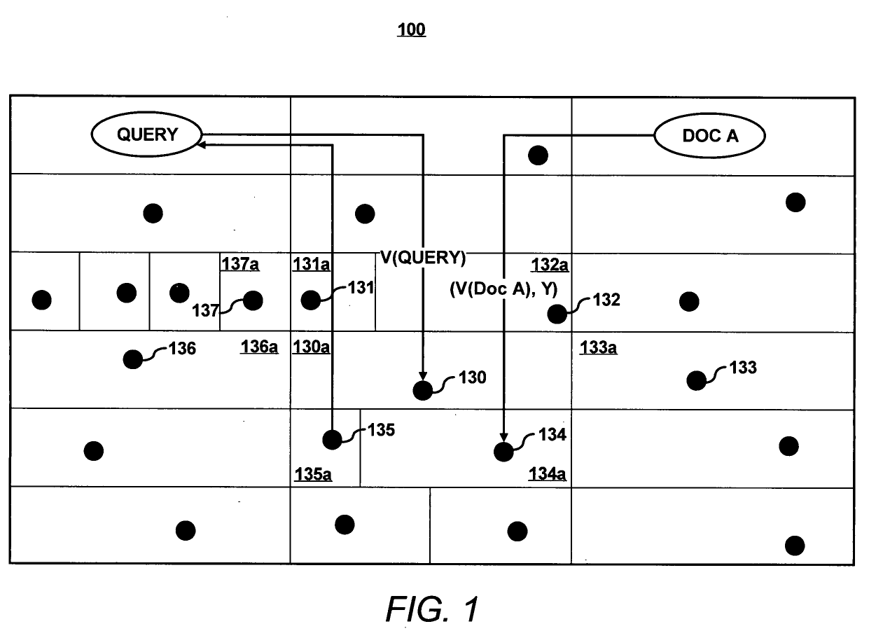

When a query is received, an LSI algorithm may be applied to the query to form a semantic query vector, V(Query). The semantic query vector is then routed in the peer search network to the node owner of the zone where the hashed semantic query vector, V(Query), falls in the peer search network. The destination node and possibly other nodes proximally located to the destination node execute the query to generate a document set, which includes a list of documents (e.g., key-value pairs identifying relevant documents) that form the search results. The query initiator may filter or rank the search results and provide the filtered retrieved information to a user. FIG. 1 illustrates routing V(Query) in an overlay network.

In many instances, highly relevant documents related to a query may not only be stored at neighbor nodes of a destination node but also at other nodes proximally located to the destination node. According to a searching embodiment, a destination node for the query uses samples from neighbor nodes M to identify one of the neighbor nodes M to continue the search. The identified one of the neighbor nodes M may use samples from its neighbor nodes N to identify one of the neighbor nodes M to continue the search. These steps may be repeated until search results substantially cannot be improved. Documents from the identified ones of the neighbor nodes M and N that closely match the query are selected for the document set forming the search results. Thus, neighbor nodes as well as other proximally located nodes having high probabilities of storing relevant documents to the query are searched. Also, these steps may be performed for different planes in the semantic space to further increase accuracy of the search results. Generating the planes is described below with respect to the rolling index.

The samples used in this embodiment may be generated in the background, such as when the node is not processing a query. The samples may include a set of documents. The documents selected for the set may be based on current documents stored at a node and recent queries executed by that node. In one embodiment, the sample includes randomly selected documents stored at the node as well as documents that have high rates or are associated with recent queries.

In another embodiment, a parameter vector may be utilized by the peer search network to ameliorate unbalanced loads in the peer search network. More particularly, a semantic vector, S, may be transformed into a parameter vector, P, in a (l−1) dimensional polar subspace. The transformation of the semantic vector, S, to the parameter vector, P, may be given by equation 1:

$${θ}_{j} = arctan ( \frac{{s}_{j + 1}}{\sqrt{{\sum }_{i = 1}^{j} {s}_{i}^{2}}} ) , j = 1 , … , l - 1 \qquad Equation 1$$

Accordingly, given an item of information the parameter vector is used to route to the appropriate node. Like SVD, the parameter vector also includes elements sorted by decreasing importance.

In yet another embodiment, the parameter vector (or semantic vector) may be applied to minimize the occurrence of hot spots. More specifically, during the process of a new node joining the peer search network, a random document that is to be published by the new node is selected. A parameter vector is created from the selected document. The new node is directed to the zone of the owner node where the parameter vector falls in the overlay network, which splits and gives part of its zone to the new node.

In yet another embodiment, multi-planing (also called rolling index) is used to reduce dimensionality while maintaining precision. In this embodiment, a single CAN network or other DHT overlay network is used to partition more dimensions of the semantic space and to reduce the search region. More particularly, the lower elements of a parameter vector (or semantic vector) are partitioned into multiple low-dimensional subvectors on different planes, whereby one subvector is on each plane. A plane is an n-dimensional semantic space for an overlay network, such as the CAN network. A single overlay network can support multiple planes.

The dimensionality of the CAN network may be set equal to that of an individual plane. For example, a semantic vector V(Doc A) for document A is generated using LSI and includes multiple elements (or dimensions) v0, v1, v2, etc. Multiple two dimensional subvectors (e.g., v0-v1, v2-v3, etc.) are generated from V(Doc A). Each subvector is mapped on its own plane in the 2-dimensional CAN overlay network. Each of the subvectors is used as the DHT key for routing.

Each of the subvectors is associated with a respective address index, where selected subvectors may be associated with the same address index. When processing a query, the query may be routed on each plane. For example, each plane corresponding to the lower subvectors may be searched because of the high probability of finding documents relevant (e.g., closely matching) to the query in these planes. Given a query, each plane independently returns matching documents, which may be added to the search results. To increase accuracy of the search results, the full semantic vectors of the returned documents and the query may be used to determine similarities between the query and the returned documents. However, partial semantic vectors may be used to determine similarities. The returned documents may form a pre-selection set which is then forwarded to the query initiator. The query initiator then uses the full semantic vector to re-rank documents.

In another multi-planing embodiment, elements of semantic vectors that correspond to the most important concepts in a certain document cluster are identified to form a plane (as opposed to using a continuous sub range of the lower elements of a semantic vector to generate subvectors). For example, clustering algorithms are applied to the semantic space to identify a cluster of semantic vectors that correspond to chemistry. A clustering algorithm that is based on a similarity matrix may include the following: (1) a document-to-document similarity function (e.g., the cosine measurement) that measures how closely two documents are related is first chosen; (2) an appropriate threshold is chosen and two documents with a similarity measure that exceeds the threshold are connected with an edge; and (3) the connected components of the resulting graph are the proposed clusters. Other known clustering algorithms may also be used. The cluster of identified semantic vectors is used to form planes. For example, elements from the cluster that are similar are identified, and subvectors are generated from the similar elements. Planes are formed from these subvectors.

In yet another multi-planing embodiment, continuous elements of a semantic vector that correspond to strong concepts in a particular document are identified to form planes. In this embodiment and the previous embodiment, not just the lower elements of a semantic vector are used to generate the searchable planes. Instead, high-dimensional elements that may include heavily weighted concepts are used to generate planes that can be searched. For example, continuous elements in the semantic vector that are associated with concepts in the item of information are identified. Subvectors are formed from the continuous elements. Planes are created from the subvectors. The planes are represented in indices including key-value pairs that may be searched in response to a chemistry-related query. Any of the multi-planing embodiments may use semantic vectors or parameter vectors.

FIG. 1 illustrates a logical diagram of an embodiment. As shown in FIG. 1, the overlay network 100 of a peer search network may be represented as a two-dimensional Cartesian space, i.e., a grid. It should be readily apparent to those skilled in the art that other dimensions and other spaces may be used. The overlay network may be a CAN or other DHT overlay network.

Each zone of the overlay network 100 includes a peer (or node) that owns the zone. For example, in FIG. 1, the black circles represent the owner nodes for their respective zones.

For example, the peer search nodes 130-137 own respective zones 130a-137a. The peer search network comprised of the peer search nodes in the overlay network 100 form a search engine for documents stored in the underlying P2P system. Nodes outside the peer search network may communicate with the peer search network to perform various functions, such as executing a search, retrieving a document, storing a document, etc.

In an embodiment, information may be stored in the overlay network 100 as key-value pairs. Each key-value pair may comprise a semantic vector and an address. The semantic vector is a mapping of semantic information space, L, into the logical space, K, of the overlay network 100. The dimensionality of the semantic information space and the logical space of the overlay network 100 may be represented as l and k, respectively. Using a rolling-index and clustering, as described above, L can be subdivided into sub vectors L=<l1, l2, . . . , Lk>, wherein each subvector defines a plane that is of the same dimension as K. Hashing may be performed by applying a predetermined hash function to the semantic vector to generate the location in the overlay network 100 for storing the key-value pair. Any well known hash function may be used, such as checksum, etc. Accordingly, the semantic vector of a document indicates a location in the overlay network 100.

The key-value pair may then be stored in the node owner of the zone where the location falls in the overlay network 100. For example, FIG. 1 shows the key-value pair (i.e., V(Doc A), Y) for document A (i.e., Doc A). The semantic vector, V(Doc A), may be computed by applying a latent semantic indexing (LSI) algorithm to Doc A. A hash function is applied to the semantic vector V(Doc A) to identify a point in the overlay network for storing the key-value pair.

As shown in FIG. 1, the key-value pair of Doc A, (V(Doc A), Y) may be routed to a point in the overlay network 100 (in this case the peer search node 130) for storage. The aggregation of key-value pairs at peer search nodes may then form indices of semantically similar information that is searchable. Therefore, instead of storing information randomly in a peer-to-peer network, such as performed in a conventional CAN, information is placed in a controlled fashion to facilitate and improve querying by aggregating similar key-value pairs on a peer search node or in nearby neighboring nodes.

When a query is received, the LSI algorithm may be applied to the query and normalized to form a semantic query vector, V(Query). The semantic query vector may then be routed to a selected node, e.g., peer search node 130, based on the semantic query vector falling in the zone owned by the peer search node 130. The peer search node 130 may search its index for any key-value pairs that match the semantic query vector. The peer search node 130 may then retrieve, filter, and forward the requested information to the initiator of the query.

In one searching embodiment, after the peer search node 130 searches its index for documents matching the query, the peer search node 130 forwards the semantic query vector to peer search nodes in a surrounding area, such as neighbor nodes 131-136. The peer search node 130 may identify other peer search nodes in surrounding areas likely to have relevant documents to the query based on samples received from the surrounding peer search nodes 131-136. For example, the peer search node 130 receives samples from each of the neighbor nodes 131-136 shown in FIG. 1. The peer search node 130 identifies which of the neighbor nodes 131-136 has a sample that is a closest match to the query. If the peer search node 136 has the closest sample, the peer search node 130 transmits the semantic query vector, V(Query), to the peer search node 136, and the peer search node 136 compares V(Query) to its index. This process may then repeated by the peer search node 136. For example, the peer search node 136 receives samples from its neighbor nodes, and identifies the neighbor node, such as the peer search node 137, having a sample that is a closest match to V(Query). The peer search node 137 then compares V(Query) to its index. This process may be repeated until the search results substantially cannot be improved.

A document set may be used to determine when to stop forwarding the query to proximally located nodes. The document set may include a list of the documents (e.g., list of key-value pairs) that are a closest match to the query. This document set when the search is completed, comprises a list of documents that are the results of the search. Initially, the peer search node 130 receiving the query may compare its index to the query to populate the document set with a predetermined number of documents that are the closest match to the query. The document set may be limited to a predetermined number of documents. The predetermined number may be set by a user or determined by software. Then, the peer search node 136 having the closest sample replaces the documents in the document set with documents that are a closer match to the query. Then, the peer search node 137 having the closest sample replaces the documents in the document set with documents that are a closer match to the query. If the peer search node 137 is unable to identify documents from its index that are a closer match to the query than documents already in the document set, the search results substantially cannot be improved. Thus, the process is stopped, and the query is not forwarded to other neighbor nodes. Also, the document set may be populated with key-value pairs stored in the indices of the peer search nodes instead of the actual document. These key-value pairs may then be used to retrieve the documents.

As described above, the searching process is stopped when the search results substantially cannot be improved. According to an embodiment, a quit threshold, T, is calculated to dynamically determine when to stop forwarding the query to proximally located nodes. T is the number of nodes that the query may be forwarded to for identifying documents that match the query. For example, if T is calculated to be 2, then the semantic vector, V(Query), is not forwarded past the peer search node 137, because the peer search node 137 is a 2-hop neighbor node of the peer search node 130. Equations 2 and 3 are used to calculate the quit threshold, T.

$$\begin{matrix}T = max ( F - 5 * i , 5 ) * {0.8}^{r} & Equation 2 \\ r = {min}_{Z ∈ Qz} Z \cdot r & Equation 3\end{matrix}$$

The predetermined value, F, is a value set by a user or a default value chosen by the system. The value, i, represents the plane where the search is conducted. The semantic space may be divided into multiple planes as described in detail above. Planes associated with lower dimensions of the semantic vector, where documents more relevant to the query are likely to be found, are searched. The value, r, is the smallest hop count between nodes submitting documents for the document set, represented as Qz. Z represents a peer search node submitting documents for the document set, Qz.

The first component of equation 2, max (F−5*i, 5), facilitates the searching of the planes in the semantic space likely to have documents most relevant to the query. At least five of the lower planes may be searched. The second component of equation 2, 0.8^{r}, functions to tighten the search area after one or more proximally located nodes have executed the query. The value of r may range between 0 and 2 because the most relevant documents to the query are likely found within the first couple neighbor hops of the destination node 130. A distance metric may be used to identify nodes proximally located to a node, such as a destination node. Examples of distance metrics include hops in the overlay network, Euclidian distance between nodes, etc.

Samples may be generated by the peer search nodes in the background, such as when a query is not being processed by a respective peer search node. A sample is a list of documents (e.g., key-value pairs) representative of the documents in the index of a particular peer search node and the result of queries recently executed by that peer search node. Each peer search node computes a semantic vector Vz that represent its samples. The semantic vector, Vz, may be calculated using the following equations:

$$\begin{matrix}Vc = {\sum }_{Vd ∈ Z} Vd + {\sum }_{k = 1}^{q} Vk & Equation 4 \\ Vz = \frac{Vc}{{‖ Vc ‖}_{2}} & Equation 5\end{matrix}$$

In equation 4, Vd are the documents in the index at a peer search node Z (e.g., one of the peer search nodes 130-137 shown in FIG. 1), and Vk are recent queries, q, executed by the peer search node Z. It has been shown that queries submitted to search engines are highly biased. Thus, a peer search node may selectively cache results for popular queries to avoid processing them repeatedly. In addition to satisfying recurrent queries, results for cached queries can be combined together to build results for new queries. Vk may include a semantic vector representation of a recent query or a combination of recent queries executed by a peer search node Z.

The first component in equation 4 is the centroid of the documents at the peer search node Z. The centroid is a value or vector used to represent the documents at the peer node Z. The second component in equation 4 is the centroid of the recent queries q executed by the peer search node Z. The centroid calculated in the second component of equation 4 is a value or vector used to represent the recent queries or results of recent requires executed at the peer node Z. Equation 5 normalizes Vc such that |Vz|₂=1.

The peer search node Z requests each of its neighbor nodes P to return Sc documents that are closest to Vz among all documents in P's index. In addition, the peer search node Z also requests P to return Sr randomly sampled documents. For example, the peer search node 130 shown in FIG. 1 requests each of its neighbor nodes 131-136 to return a list of documents that are closest to the semantic vector Vz for the peer search node 130. The peer search node 130 also requests each of its neighbor nodes 131-136 to send a list of randomly selected documents from respective indices. A sample is generated for each of the peer search nodes 131-136 from the lists received from each of the peer search nodes 131-136. An example of a sample may include 0.8 Sc+0.2Sr for each neighbor node 131-136. However, the ratio of randomly sampled documents, Sr, to documents, Sc, close to the semantic vector Vz for a sample may be set differently based on a variety of factors, including accuracy of search results.

After the peer search node 130 receives the samples from the neighbor nodes 131-136, the peer search node 130 compares the samples to the query. Both the samples and the query may be represented by a vector, and a cosine function may be used to determine which sample is closest to the query. The following equation may be used to determine the similarity between a sample represented by the semantic vector X, and a query represented by the semantic vector Vq.

$$P \cdot sim = {max}_{X ∈ Sp} cos ( X , Vq ) \qquad Equation 6$$

P.sim is the sample from one of the neighbor nodes 131-136 that is most similar to the query. The cosine function may be used, such as shown in equation 6, to determine the similarity between two semantic vectors, which in this case is the semantic vector X for each of the samples from the neighbor nodes 131-136 and the semantic vector for the query Vq.

Generally, a cosine function may be used to determine how close semantic vectors match. For example, a cosine between a semantic query vector and each of the semantic vectors in key-value pairs in an index of a peer search node is determined to identify documents that most closely match a query.

The semantic space may be rotated to compensate for dimension mismatches between the semantic vectors and the overlay network 100. For example, the semantic space of the overlay network 100 is divided into multiple planes. Equation 5 may be used to compare semantic vectors on one or more of the planes.

Index replication may be used to balance loads among the peer search nodes or for fault tolerance. For example, the index of the peer search node 131 may be stored on the peer search node 130. Thus, if the load of the peer search node 130 is low, the peer search node 130 may execute queries for the peer search node 131. Also, if the peer search node 131 fails, the peer search node 130 may take over processing for the peer search node 131 without notice to the user. Also, the peer search node 130 may be designated as a search node for a region in the overlay network 100 encompassing the peer search nodes 131-137. Then, the peer search node 130 stores the indices of the peer search nodes 131-137. Thus, queries for the region may be executed by one peer search node instead of being transmitted to multiple-hop neighbor nodes.

Indices may be selectively replicated in the background, such as when a query is not being executed. The sampling process described above may be used as criteria for selective replication. For example, using equations 4 and 5, the peer search node 130 computes a semantic vector, V1130, to represent itself and request its direct and indirect neighbor nodes to return all indices whose similarity to V130 is beyond a threshold. The threshold is determined by the radius of the region covered by this replication. Queries to documents within this replication region can be processed by the peer search node 130.

In another embodiment, a parameter vector along with an address index may form key-value pairs to be stored in the overlay network 100 to improve load balancing. More particularly, the formation of semantic vector involves normalization, which then resides on a unit sphere in the semantic information space, L. However, the normalization may lead to an unbalanced consolidation of key-value pairs. Accordingly, a transformation of equation (1) is applied the semantic vector to form the parameter vector, which maps the semantic vector into a (l−1) dimensional polar subspace, P. The parameter vector is then used to publish information and to query information similar to the use of the semantic vector.

In yet another embodiment, the parameter vector (or semantic vector) may be utilized to even the distribution of the key-value pairs. More specifically, a semantic vector or parameter vector is generated for information to be published in the overlay network 100. The semantic vector or parameter vector is used as a key to identify a node in the overlay network 100 for storing the information. When a new node joins the overlay network 100, an item of information may be randomly selected from the publishable contents of the new node. The LSI algorithm may be applied to the item of information to form the semantic vector. Subsequently, the semantic vector is transformed into a respective parameter vector. The new node then joins by splitting and taking over part of the zone of where parameter vector (or semantic vector) falls in the overlay network 100. This results in a node distribution being similar to the document distribution.

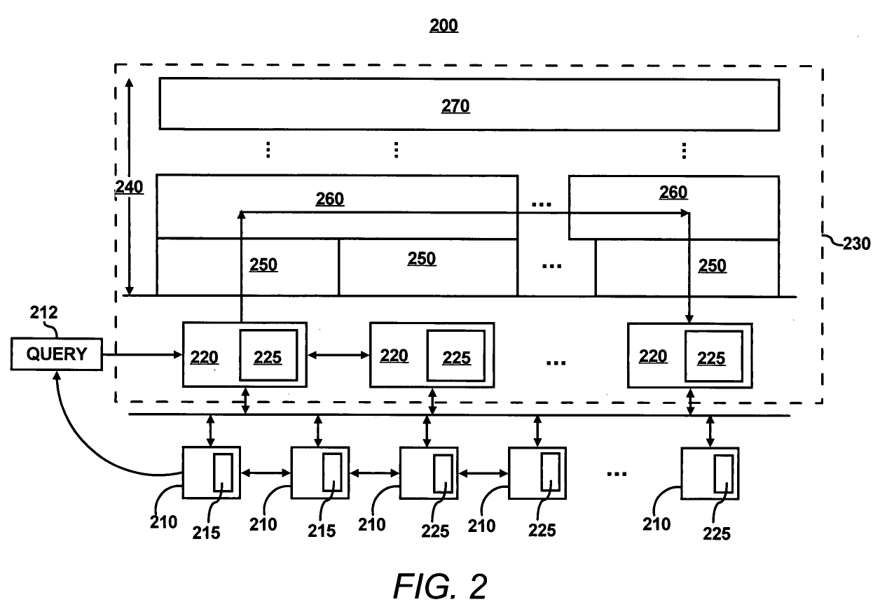

FIG. 2 illustrates a block diagram of a P2P system 200, according to an embodiment. A subset of the nodes in the P2P system 200 form the underlying P2P system for the overlay network 100 shown in FIG. 1. The nodes (or peers) 210 include nodes in the P2P system 200. Each of the nodes 210 may store and/or produce objects, such as documents (e.g., Doc A shown in FIG. 1), web pages, music files, video, and other types of data. The objects may be stored in a dedicated storage device (e.g., mass storage) 215 accessible by the respective node. The nodes 210 may be computing platforms (e.g., personal digital assistants, laptop computers, workstations, etc.) that have a network interface.

The nodes 210 may be configured to exchange information among themselves and with other network nodes over a network (not shown). The network may be configured to provide a communication channel among the nodes 210. The network may be implemented as a local area network, wide area network or combination thereof. The network may implement wired protocols such as Ethernet, token ring, etc., wireless protocols such as Cellular Digital Packet Data, Mobitex, EEE 801.11b, Wireless Application Protocol, Global System for Mobiles, etc., or combination thereof.

The P2P system 200 may also include a subset of nodes 220 that function as a peer search network 230. The subset of nodes 220 may include the peer search nodes 130-137 shown in FIG. 1. The peer search network 230 operates as a search engine for queries, which may be submitted by the nodes 210. The peer search network 230 also permits controlled placement of key-value pairs within the overlay network 100. In the peer search network 230, objects are represented as indices comprised of key-value pairs. A key-value pair may comprise a semantic (or parameter) vector of an object and an address for the object (e.g., URL, IP address, or the object itself). According to an embodiment, a semantic vector for an object is used as a key (e.g., hashing the semantic vector) to determine a location for placing the object in the overlay network 100 comprised of the nodes 220. Thus, semantic vectors that are similar are stored at nodes 220 in the overlay network 100 that are proximally located, such as within a limited number of hops, to each other in the overlay network 100.

When a query 212 is received, a vector representation of the query is generated. For example, the LSI algorithm may be applied to the query 212 to form the semantic query vector. The semantic query vector is then routed to a node 220 (i.e., the destination node) in the peer search network 230. The destination node receiving the query is determined by hashing the semantic query vector to identify a location in the overlay network 100. The destination node receiving the semantic query vector, for example, is the node in the overlay network 100 owning the zone where the location falls.

After reaching the destination node, the destination node searches its index of key-value pairs to identify objects (which may include documents) relevant to the query 212. Determining whether an object is relevant to the query 212 may be performed by comparing the semantic query vector to semantic vectors stored in the index. Semantic vectors in the index that are a closest match to the semantic query vector may be selected for the search results. The semantic query vector may be forwarded to one or more other nodes 220 proximally located to the destination node based on samples received from the nodes 220. The semantic query vector may be forwarded to one or more of the nodes 220 having samples closely related to key-value pairs stored at the destination node and possibly other nodes executing the search. Also, indices for a plurality of the nodes 220 may be replicated in one or more of the nodes 220. Thus, one node receiving the semantic query vector may search a plurality of indices related to a plurality of the nodes 220 without forwarding the semantic query vector to each of the plurality of nodes. Also, in a multi-planing embodiment, the semantic query vector may be used to search indices at nodes 220 on different planes of the overlay network 100.

The search results, which may include a document set comprised of key-value pairs identifying objects relevant to the query, may be returned to the query initiator, shown as one of the nodes 210 in the P2P system 200. The query initiator may rank the search results based on full semantic vectors for the key-value pairs in the search results.

In another embodiment, the peer search network 230 may be configured to include an auxiliary overlay network 240 for routing. A logical space formed by the peer search network 230 may be a d-torus, where d is the dimension of the logical space. The logical space is divided into fundamental (or basic) zones 250 where each node of the subset is an owner. Additional zones 260, 270 are formed over the fundamental zones may be provided for expressway routing of key-value pairs and queries.

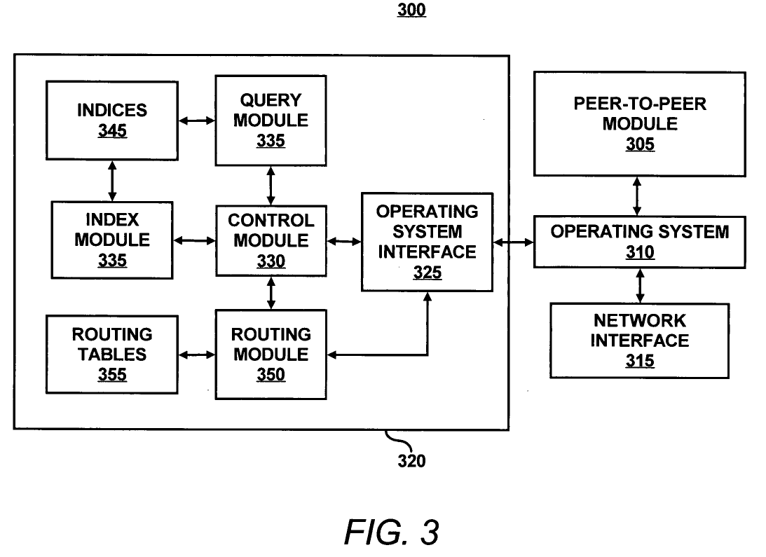

FIG. 3 illustrates an exemplary architecture 300 that may be used for one or more of the nodes 220 shown in FIG. 2, according to an embodiment. It should be readily apparent to those of ordinary skill in the art that the architecture 300 depicted in FIG. 3 represents a generalized schematic illustration and that other components may be added or existing components may be removed or modified. Moreover, the architecture 300 may be implemented using software components, hardware components, or a combination thereof.

As shown in FIG. 3, the architecture 300 may include a P2P module 305, an operating system 310, a network interface 315, and a peer search module 320. The P2P module 305 may be configured to provide the capability to a user of a node to share information with another node, i.e., each node may initiate a communication session with another node. The P2P module 305 may be a commercial off-the-shelf application program, a customized software application or other similar computer program. Such programs such as KAZAA, NAPSTER, MORPHEUS, or other similar P2P applications may implement the P2P module 305.

The peer search module 320 may be configured to monitor an interface between the P2P module 305 and the operating system 315 through an operating system interface 325. The operating system interface 310 may be implemented as an application program interface, a function call or other similar interfacing technique. Although the operating system interface 320 is shown to be incorporated within the peer search module 320, it should be readily apparent to those skilled in the art that the operating system interface 325 may also incorporated elsewhere within the architecture of the peer search module 320.

The operating system 310 may be configured to manage the software applications, data and respective hardware components (e.g., displays, disk drives, etc.) of a peer. The operating system 310 may be implemented by the MICROSOFT WINDOWS family of operating systems, UNIX, HEWLETT-PACKARD HP-UX, LINUX, RIM OS, and other similar operating systems.

The operating system 310 may be further configured to couple with the network interface 315 through a device driver (not shown). The network interface 315 may be configured to provide a communication port for the respective node over a network. The network interface 315 may be implemented using a network interface card, a wireless interface card or other similar input/output device.

The peer search module 320 may also include a control module 330, a query module 335, an index module 335, at least one index (shown as ‘indices’ in FIG. 3) 345, and a routing module 350. The peer search module 320 may be configured to implement the peer search network 230 shown in FIG. 2 for the controlled placement and querying of key-value pairs in order to facilitate searching for information. The peer search module 320 may be implemented as a software program, a utility, a subroutine, or other similar programming entity. In this respect, the peer search module 320 may be implemented using software languages such as C, C++, JAVA, etc. Alternatively, the peer search module 320 may be implemented as an electronic device utilizing an application specific integrated circuit, discrete components, solid-state components or combination thereof.

The control module 330 of the peer search module 320 may provide a control loop for the functions of the peer search network. For example, if the control module 330 determines that a query message has been received, the control module 330 may forward the query message to the query module 335.

The query module 335 may be configured to provide a mechanism to respond to queries from peers (e.g., peers 110) or other peer search nodes (e.g., 120). The query module 335 may search its index of key-value pairs based on a semantic query vector. The query module 335 may also identify other nodes 220 shown in FIG. 2 for executing the query based on samples received from the other nodes 220. The query module 230 may also determine whether a quit threshold has been reached, which determines whether to forward the semantic query vector to another node that may store information relevant to the query. In addition, the indices 345 may include replicated indices of other proximally located nodes and results of recently executed queries. The query module 335 may search these indices to identify information relevant to the query. The query module 335 may also forward a sample, which may be stored with the indices 345, to another node requesting a sample.

The indices 345 may comprise a database storing indices, samples, results of recent queries, etc. The indices module 345 may be maintained as a linked-list, a look-up table, a hash table, database or other searchable data structure. The index module 335 may be configured to create and maintain the indices 345. In one embodiment, the index module 335 may receive key-value pairs published by other nodes. In another embodiment, the index module 335 may actively retrieve, i.e., ‘pull’, information from the other nodes. The index module 335 may also apply the vector algorithms to the retrieved information and form the key-value pairs for storage in the indices 345.

The control module 330 may also be interfaced with the routing module 350. The routing module 350 may be configured to provide routing, which may include expressway routing, for semantic query vectors and key-value pairs.

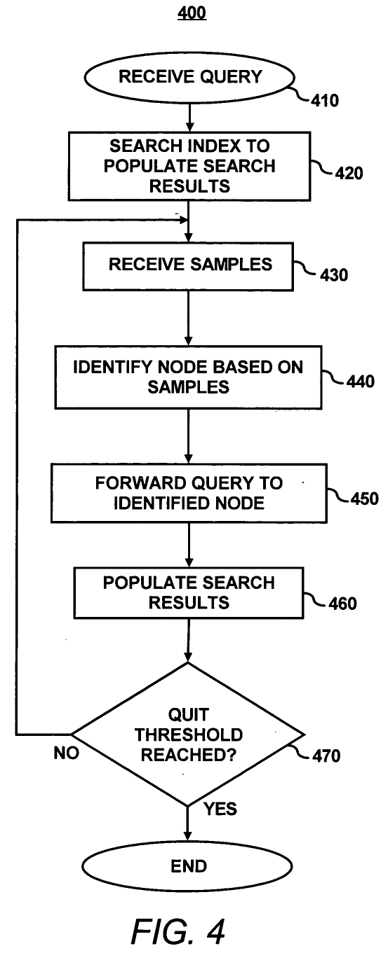

FIG. 4 illustrates a flow diagram of a method 400 for executing a query in a P2P system, according to an embodiment. The method 400 is described with respect to the overlay network 100 shown in FIG. 1 by way of example and not limitation. It should be readily apparent to those of ordinary skill in the art that the method 400 represents a generalized method and that other steps may be added or existing steps may be removed or modified. The method 400 may be performed by software, hardware, or a combination thereof.

At step 410, a destination node (e.g., the peer search node 130 shown in FIG. 1) receives a query. The query may be a semantic vector generated from the query, such as V(Query) shown in FIG. 1. The V(Query) may be hashed to identify a location in the overlay network 100 shown in FIG. 1, such as the peer search node 130, for receiving and executing the query.

At step 420, the destination node searches its index of key-value pairs to identify semantic vectors relevant to the query for populating the search results. At step 430, the destination node receives samples from peer search nodes proximally located to the destination node in the overlay network 100. For example, the peer search node 130 receives samples from its neighbor nodes 131-136. Proximally located nodes may include neighbor nodes and/or other peer search nodes located within a predetermined distance (e.g., a limited number of hops) from the destination node. The destination node may also generate samples from key-value pairs received from the peer search nodes. For example, the destination node may receive a set of randomly selected documents and set of documents closely matching a semantic vector, Vz, for the destination node from each of the proximally located peer search nodes. The destination node generates samples from the received information.

At step 440, the destination node identifies a proximally located peer search node likely storing information relevant to the query based on the received samples. For example, the peer search node 130 compares vector representations of the samples to V(Query) to identify the sample most closely related to the query. The peer search node 130 selects, for example, the peer search node 131, because the sample for the peer search node 131 most closely matches the query.

At step 450, the destination node forwards the query (e.g., V(Query) to the peer search node identified at step 440 (e.g., the peer search node 131). At step 460, the identified peer search node populates the search results. This may include replacing some of the results populated at the step 420. For example, at step 420, the peer search node 130 populates a document set (e.g., the search results) with semantic vectors from its index. At the step 460, the peer search node 131 replaces one or more of the semantic vectors in the document set with semantic vectors in its index that more closely match the V(Query).

At step 470, the node identified at step 440 determines whether a quit threshold is reached. The quit threshold is used to determine whether the search results can be improved, for example, by searching an index of another peer search node likely to store information relevant to the query. The quit threshold may be based on the number of hops a peer search node is from the destination node. The quit threshold may also be based on whether the current peer search node (e.g., the peer search node 131) includes at least one semantic vector that more closely matches the V(Query) than any other semantic vector in the document set.

If the quit threshold is reached at step 470, then the method 400 ends. Otherwise, the method 500 returns to the step 430, and the query may be forwarded to another peer search node (e.g., the peer search node 137) which is proximally located to the peer search node 131.

The method 400 may be performed for multiple planes in the overlay network. Furthermore, the multiple planes may be concurrently searched to improve response times. Also, the destination node and/or other peer search nodes may replicate indices of proximally located peer search nodes based on the samples received from the proximally located peer search nodes. For example, if the peer search nodes 131 and 132 have samples that most closely match content (e.g., semantic vectors in an index) stored at the peer search node 130 when compared to other proximally located peer search nodes, the peer search node 130 may store indices from the peer search nodes 131 and 132. Also, the peer search node 130 may store indices for all peer search nodes within a region in the overlay network 100, which may comprise multiple proximally located zones in the overlay network 100. Thus, the peer search node 130 may search indices from a plurality of peer search nodes without forwarding the query.

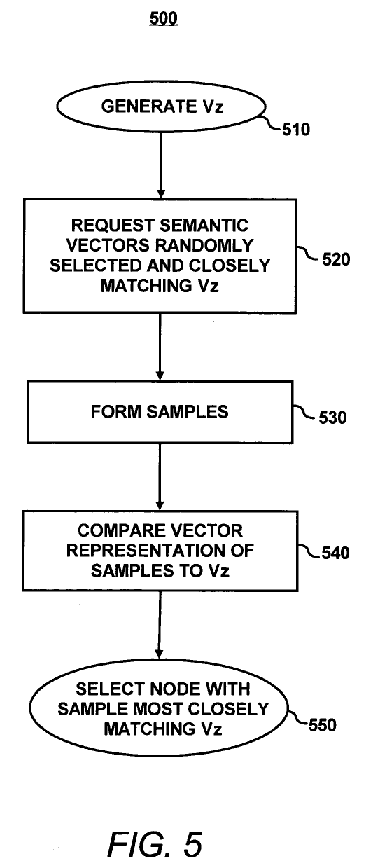

FIG. 5 illustrates a flow diagram of a method 500 for generating samples, according to an embodiment. The method 500 includes steps that may be performed at steps 430 and 440 of the method 400 shown in FIG. 4. The method 500 is described with respect to the overlay network 100 shown in FIG. 1 by way of example and not limitation. It should be readily apparent to those of ordinary skill in the art that the method 500 represents a generalized method and that other steps may be added or existing steps may be removed or modified. The method 500 may be performed by software, hardware, or a combination thereof.

At step 510, a peer search node (e.g., the peer search node 130 shown in FIG. 1) generates a semantic vector, Vz, representative of the semantic vectors stored at the peer search node and the results of one or more queries recently executed by the peer search node.

At step 520, the peer search node requests proximally located peer search nodes to send semantic vectors (or key-value pairs including the semantic vectors) stored at the respective peer search nodes that are closest matches to the query (e.g., V(Query)). The peer search node also requests the proximally located peer search nodes to send randomly selected semantic vectors (or key-value pairs including the semantic vectors) stored at the respective peer search nodes. For example, each of the peer search nodes 131-136 shown in FIG. 1 sends the requested semantic vectors (or key-value pairs from their indices) to the peer search node 130.

At step 530, the peer search node forms samples for each of the proximally located peer search nodes based on the semantic vectors received from the proximally located peer search nodes. For example, the peer search node 130 forms samples for each of the peer search nodes 131-136.

At step 540, the peer search node compares a vector representation (e.g., a semantic vector) of the samples to Vz. At step 550, the peer search node selects one of the proximally located nodes having a sample most closely matching Vz. For example, if a vector representation of the sample for the peer search node 131 most closely matches Vz, the peer search node 130 selects the peer search node 131. Then, the query may be forwarded to the peer search node 131, such as shown at step 450 shown in FIG. 4.

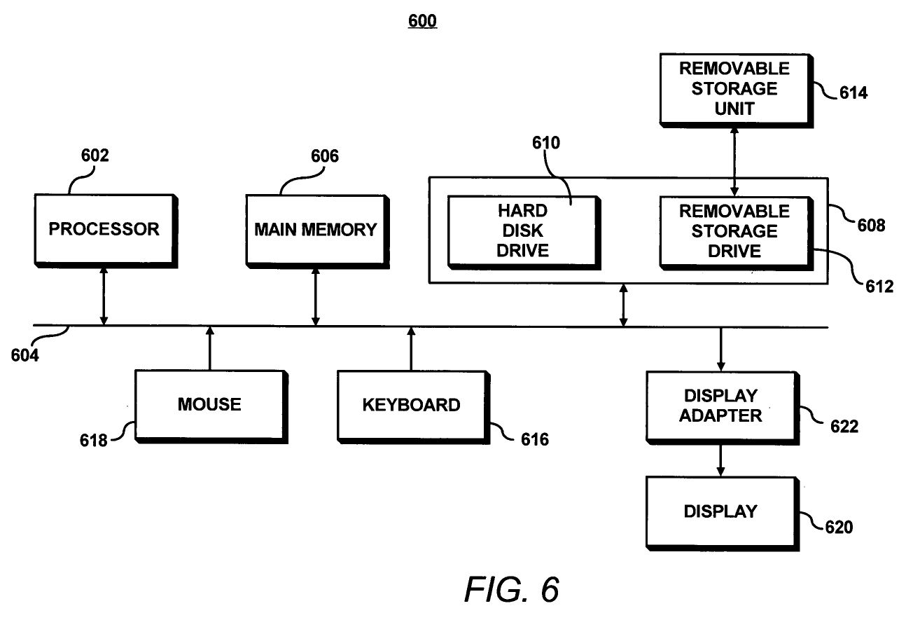

FIG. 6 illustrates an exemplary block diagram of a computer system 600 where an embodiment may be practiced. The modules in FIG. 3 may be executed by the computer system 600. As shown in FIG. 6, the computer system 600 includes one or more processors, such as processor 602 that provide an execution platform. Commands and data from the processor 602 are communicated over a communication bus 604. The computer system 600 also includes a main memory 606, such as a Random Access Memory (RAM), where the software for the modules may be executed during runtime, and a secondary memory 608. The secondary memory 608 includes, for example, a hard disk drive 610 and/or a removable storage drive 612, representing a floppy diskette drive, a magnetic tape drive, a compact disk drive, etc., where a copy of a computer program embodiment for the range query module may be stored. The removable storage drive 612 reads from and/or writes to a removable storage unit 614 in a well-known manner. A user interfaces with a keyboard 616, a mouse 618, and a display 620. The display adaptor 622 interfaces with the communication bus 604 and the display 620 and receives display data from the processor 602 and converts the display data into display commands for the display 620.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

1. A method for executing a search in a peer-to-peer system, the method comprising:
receiving a query at a destination node;
receiving samples from a first set of nodes proximally located to the destination node in an overlay network for the peer-to-peer system, the samples associated with information stored at the proximally located nodes; and
identifying, based on the samples received from the first set of nodes, a first node of the first set of nodes likely storing information associated with objects stored in the peer-to-peer system that are relevant to the query.

2. The method of claim 1, further comprising:
comparing the query to information stored in the first node; wherein the information stored in the first node is associated with objects stored in the peer-to-peer network; and
generating search results including information stored in the first node associated with objects relevant to the query based on the comparison of the query to the information stored in the first node.

3. The method of claim 2, further comprising:
determining whether a quit threshold has been reached;
transmitting the search results to an initiator of the query in response to the quit threshold being reached; and
performing the following steps in response to the quit threshold not being reached:
identifying a second node likely storing information associated with objects stored in the peer-to-peer network that are relevant to the query based on samples received from a second set of nodes including the second node, wherein the second set of nodes are nodes proximally located to the first node in the overlay network; and
adding information stored in the second node to the search results;
the added information being associated with objects that are relevant to the query.

4. The method of claim 3, wherein the quit threshold is associated with at least one of hops in the overlay network and whether the search results can be improved by adding information to the search results from the second node.

5. The method of claim 1, further comprising:
generating semantic vectors for objects stored in the peer-to-peer system;
hashing each of the semantic vectors to generate keys identifying locations in the overlay network for storing key-value pairs for the objects, wherein the keys are the semantic vectors for the objects and the values include at least one of the objects and addresses for the objects; and
storing the key-value pairs at nodes associated with the locations in the overlay network such that the stored key-value pairs associated with similar semantic vectors are proximally located in the overlay network.

6. The method of claim 5, further comprising:
generating the samples for the first set of nodes as a function of at least one of key-value pairs stored at each of the first set of nodes.

7. The method of claim 6, wherein generating the samples comprises:
generating a destination node semantic vector representative of objects associated with at least one of key-value pairs stored at the destination node and recent queries executed by the destination node;
generating a list of key-value pairs for each node of the first set of nodes, wherein each list includes key-value pairs associated with objects having semantics similar to the destination node semantic vector.

8. The method of claim 7, wherein identifying, based on the samples received from the first set of nodes, a first node of the first set of nodes likely storing information associated with objects stored in the peer-to-peer network that are relevant to the query comprises:
generating a semantic vector for each of the samples for the first set of nodes;
comparing the destination node semantic vector to each of the semantic vectors for the first set of nodes; and
identifying one of the semantic vectors for the first set of nodes closest to the destination node semantic vector.

9. The method of claim 5, further comprising:
identifying lower elements for the semantic vectors;
generating planes in the overlay network associated with the lower elements; and
performing the steps of claim 1 for each of the planes.

10. The method of claim 5, further comprising:
storing indices of key-value pairs at the nodes;
replicating an index for a second node in the first node, wherein the second node is proximally located to the first node in the overlay network; and
identifying key-value pairs from the replicated index that are relevant to the query.

11. The method of claim 5, further comprising:
storing indices of key-value pairs at the nodes;
in the first node, replicating indices for a plurality of nodes in a region in the overlay network including the first node; and
identifying key-value pairs from the replicated indices that are relevant to the query.

12. The method of claim 2, wherein the first set of nodes are neighbor nodes to the destination node in the overlay network.

13. The method of claim 3, wherein the second set of nodes are neighbor nodes to the first node in the overlay network.

14. An apparatus for executing a search in a peer-to-peer system, the apparatus comprising:
means for receiving a query at a destination node;
means for receiving samples from a first set of nodes proximally located to the destination node in an overlay network for the peer-to-peer system, the samples associated with information stored at the proximally located nodes; and
means for identifying, based on the samples received from the first set of nodes, a first node of the first set of nodes likely storing information associated with objects stored in the peer-to-peer system that are relevant to the query.

15. The apparatus of claim 14, further comprising:
means for comparing the query to information stored in the first node;
wherein the information stored in the first node is associated with objects stored in the peer-to-peer network; and
means for generating search results including information stored in the first node associated with objects relevant to the query based on the comparison of the query to the information stored in the first node.

16. The apparatus of claim 15, further comprising:
means for determining whether a quit threshold has been reached;
means for transmitting the search results to an initiator of the query in response to the quit threshold being reached; and
means for performing the following functions in response to the quit threshold not being reached:
identifying a second node likely storing information associated with objects stored in the peer-to-peer network that are relevant to the query based on samples received from a second set of nodes including the second node, wherein the second set of nodes are nodes proximally located to the first node in the overlay network; and
adding information stored in the second node to the search results;
the added information being associated with objects stored in the peer-to-peer system that are relevant to the query.

17. The apparatus of claim 16, wherein the quit threshold is associated with at least one of hops in the overlay network and whether the search results can be improved by adding information to the search results from the second node.

18. A computer readable medium on which is embedded a program, the program performing a method, the method comprising:
receiving a query at a destination node;
receiving samples from a first set of nodes proximally located to the destination node in an overlay network for the peer-to-peer system, the samples associated with information stored at the proximally located nodes; and
identifying, based on the samples received from the first set of nodes, a first node of the first set of nodes likely storing information associated with objects stored in the peer-to-peer system that are relevant to the query.

19. The computer readable medium of claim 18, wherein the method further comprises:
comparing the query to information stored in the first node; wherein the information stored in the first node is associated with objects stored in the peer-to-peer network; and
generating search results including information stored in the first node associated with objects relevant to the query based on the comparison of the query to the information stored in the first node.

20. The computer readable medium of claim 19, wherein the method further comprises:
determining whether a quit threshold has been reached;
transmitting the search results to an initiator of the query in response to the quit threshold being reached; and
performing the following steps in response to the quit threshold not being reached:
identifying a second node likely storing information associated with objects stored in the peer-to-peer network that are relevant to the query based on samples received from a second set of nodes including the second node, wherein the second set of nodes are nodes proximally located to the first node in the overlay network; and
adding information stored in the second node to the search results;
the added information being associated with objects stored in the peer-to-peer system that are relevant to the query.

21. The computer readable medium of claim 20, wherein the quit threshold is associated with at least one of hops in the overlay network and whether the search results can be improved by adding information to the search results from the second node.

22. A peer-to-peer system comprising:
a plurality of nodes in the system operating as a search engine operable to execute a query received by the search engine;
an overlay network implemented by the plurality of nodes;
a plurality of indices stored at the plurality of nodes, each index including at least one semantic vector for an object;
wherein a first node in the search engine is operable to receive samples from nodes proximally located to the first node in the overlay network, the first node utilizing the samples to identify an index of one of the other nodes to search in response to receiving the query.

23. The system of claim 22, wherein similar semantic vectors are stored at nodes proximally located in the overlay network.

24. The system according to claim 23, wherein the first node is located in a region in the overlay network and the first node is operable to store indices from nodes in the region, such that the first node is operable to search a plurality of indices likely to include information relevant to the query without forwarding the query to other nodes in the region.
